(19) United States
(12) Patent Application Publication
(10) Pub. No.: US 2009/0260944 A1
(43) Pub. Date: Oct. 22, 2009

(54) Electromagnetic actuating device with driving and holding tapped coil

(76) Inventor: Tai-Her Yang, Dzan-Hwa (TW)

Correspondence Address: BACON & THOMAS, PLLC, 625 SLATERS LANE, FOURTH FLOOR, ALEXANDRIA, VA, 22314-1176, US

(21) Appl. No.: 12/081,713

(22) Filed: Apr. 21, 2008

(51) Int. Cl. F16D 27/02

(52) U.S. Cl. 192/84.1

(57) ABSTRACT

The present invention discloses that the driving coil of lower impedance having a driving tap and a common connection being electrically actuated to obtain larger actuating force is further operatively controlled by the switching device to be switched to have relatively higher impedance thus allowing smaller current to pass thereby holding electrification or excitation while required operating characteristics of the electromagnetic actuating device can still be satisfied.

### BACKGROUND OF THE INVENTION

(a) Field of the Invention

The present invention is mainly related to an electromagnetic actuating device installed with a driving coil having driving and holding taps and the common connector, wherein the driving coil having a driving tap and a common connector to appear lower impedance is operatively controlled by the switching device to be electrified for excitation, then after actuation, said driving coil having a holding tap and a common connector is further operatively controlled by the switching device to be switched to appear higher impedance to hold electrification for excitation, thus reducing currents passing through the driving coil while required operating characteristics of the electrified electromagnetic actuating device to electromagnetic actuation are still satisfied thereby saving electric power and reducing heat loss in the driving coil of the electromagnetic actuating device.

(b) Description of the Prior Art

For the conventional electromagnetic actuating device driven by passing currents through driving coils to produce the electromagnetic actuating effect, the coil electrification status remains unchanged when the electrification status is actuated and held, i.e. the required excited currents for actuating and holding electrification are the same, therefore it has disadvantages of high heat loss and wasting electric energy.

### SUMMARY OF THE INVENTION

The present invention discloses an electromagnetic actuating device with the driving and holding tapped coil, wherein the driving coil of the electromagnetic actuating device having driving and holding taps and the common connector is operatively controlled by the switching device, wherein it includes applications for normal close or normal open type electromagnetic brakes, normal close or normal open type electromagnetic clutches, normal close or normal open type electromagnetic switches, normal close or normal open type electromagnetic relays, normal close or normal open type solenoid valves, etc. as well as electromagnets, electromagnetic locks, spiral tube windings or other electromagnetic actuating devices with driving coils for electromagnetic driving effects, or operating type electromagnetic actuating devices which can be driven by driving coils or operated by numerous manual or mechanical power methods; wherein the driving coil having driving tap and common connector to appear lower impedance being electrically actuated to produce a larger electromagnetic actuating force on the electromagnetic actuating device is operatively controlled by the switching device to be switched to appear relatively higher impedance thereby holding electrification for excitation thus reducing total current passing through the driving coil, while required operating characteristics of the electrified electromagnetic actuating device can still be satisfied thereby saving electric power and reducing heat loss in the driving coil of the electromagnetic actuating device.

### BRIEF DESCRIPTION OF THE DRAWINGS

FIG. 1 is a circuit-block schematic view showing that the electromagnetic actuating device with driving and holing tapped coils in the embodiment of the invention is electrically actuated for excitation at lower impedance for excitation and held electrification for excitation at higher impedance.

FIG. 2 is a circuit schematic view showing that the driving coil with a driving tap and a common connector in the embodiment of FIG. 1 is electrified for excitation.

FIG. 3 is a circuit schematic view showing that driving coil having a holding tap and a common connector in the embodiment of FIG. 1 is holding electrification for excitation.

FIG. 4 is a schematic view showing that two ends of the driving coil are respectively a holding tap and a common connector, while the middle tap is a driving tap.

FIG. 5 is a schematic view showing that two ends of the driving coil are respectively a holding tap and a driving tap, while the middle tap is a common connector.

FIG. 6 is a schematic view showing that the driving coil is constituted by individual driving coil and holding coil.

FIG. 7 is a circuit-block schematic view showing that the electromagnetic actuating device is installed with a position detector device to operatively control the driving coil.

FIG. 8 is a circuit schematic view of a DC power application example of the present invention showing that a charge/discharge capacitor being parallel connected between the holding tap and the driving tap is switched and cut-off power with a delay.

### DESCRIPTION OF MAIN COMPONENT SYMBOLS

101: Switching device
102: Electromagnetic actuating device
103, 113: Surge absorption device
105: Position detector device
102′: Driving coil
1021: Driving coil
1022: Holding coil
C1: Charge/discharge capacitor
Ia: Excited current by electrical actuation
Ib: Excited current by holding electrification
T0: Common connector
T1: Driving tap
T2: Holding tap

### DETAILED DESCRIPTION OF THE PREFERRED EMBODIMENTS

The present invention discloses an electromagnetic actuating device with a driving coil having driving and holding taps and the common connector being operatively controlled by a switching device, wherein it includes applications for normal close or normal open type electromagnetic brakes, normal close or normal open type electromagnetic clutches, normal close or normal open type electromagnetic switches, normal close or normal open type electromagnetic relays, normal close or normal open type solenoid valves, etc. as well as electromagnets, electromagnetic locks, spiral tube windings or other electromagnetic actuating devices with driving coils for electromagnetic driving effects, or operating type electromagnetic actuating devices which can be driven by driving coils or operated by numerous manual or mechanical power methods; wherein the driving coil having driving tap and common connector to appear lower impedance being electrically actuated to produce a larger electromagnetic actuating force on the electromagnetic actuating device is operatively controlled by the switching device to be switched to appear relatively higher impedance thereby holding electrification for excitation thus reducing total current passing through the driving coil, while required operating characteristics of the electrified electromagnetic actuating device can still be satisfied thereby saving electric power and reducing heat loss in the driving coils of the electromagnetic actuating device.

The embodiments of the electromagnetic actuating device with the driving and holding tapped coil are described in the following:

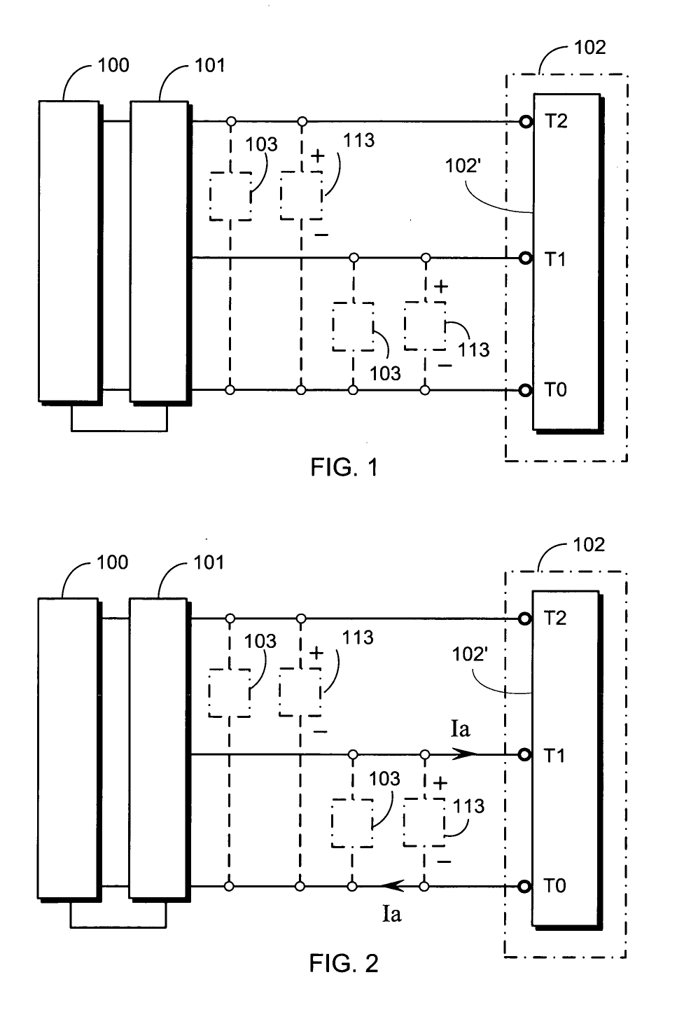

FIG. 1 is a circuit-block schematic view showing that the electromagnetic actuating device with the driving and holing tapped coil in the embodiment of the invention is electrically actuated for excitation at lower impedance and held electrification for excitation at higher impedance, wherein it mainly comprises:

A power source device (100): It is constituted by electrical machineries, electronic components, or power source supply devices containing microprocessor and relevant software with relevant power supply functions as well as voltage and current control functions to receive DC or AC power supply and to be operatively controlled by the switching device (101) to provide AC power output or DC power output of lower voltage, or DC power output of semi-wave or full waved or chopped wave, etc;

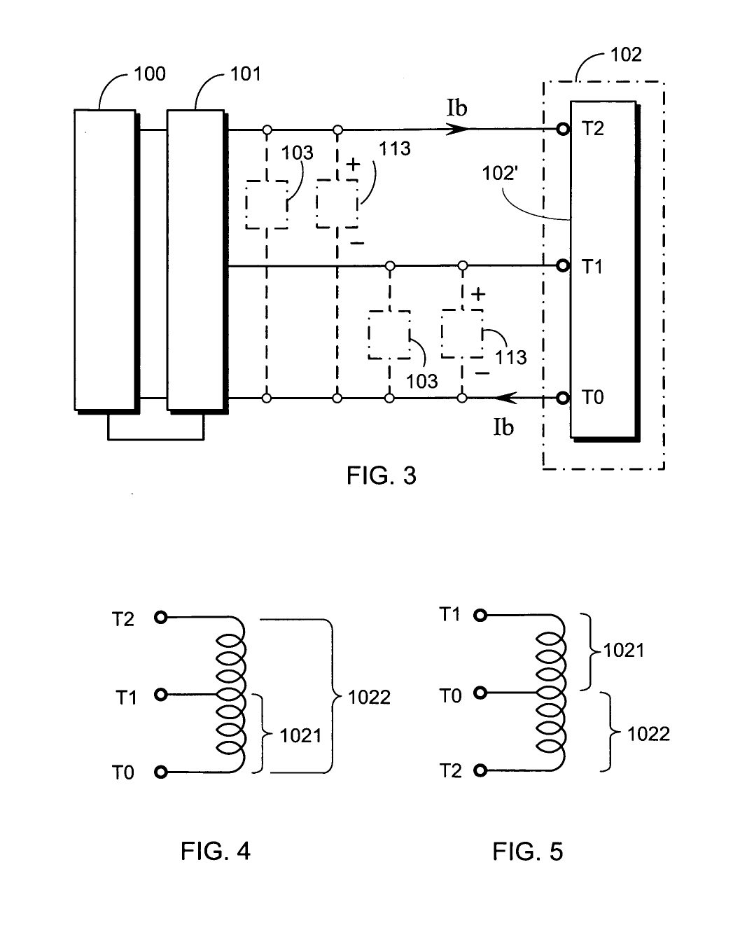

A switching device (101): It is constituted by an electromechanical switch, an electric relay, an electromagnetic switch or a solid state switching device, etc. operable by the manual, mechanical, fluid or electrical power being operated by the manual, mechanical, fluid or electrical power is through supplying AC or DC power to the driving coil (102′) of the electromagnetic actuating device (102) having a driving tap (T1), a holding tap (T2) and a common connector (T0) to provide a switching function for electrification and power cut-off, or it is through the switchover operation by the switching device (101) to allow the driving coil (102′) having a driving tap (T1) and a common connector (T0) to appear relatively lower impedance to be electrified by passing through excited current (Ia) for excitation. FIG. 2 is a circuit schematic view showing that the driving coil with a driving tap and a common connector in the embodiment of FIG. 1 is electrified for excitation, wherein the driving coil (102′) being actuated for excitation by AC power input is operatively controlled by the switching device (101) to be switched to have a holding tap (T2) and a common connector (T0) to hold electrification by passing excited current (Ia) for excitation. FIG. 3 is a circuit schematic view showing that the driving coil having a holding tap and a common connector in the embodiment of FIG. 1 is holding electrification for excitation, wherein total current on the driving coil is reduced, while operating characteristics of the electrified electromagnetic actuating device is still ensured by the electromagnetic effective force, thereby saving electric power and reducing heat generation in the electromagnetic actuating device.

For the electromagnetic actuating device with a driving and a holding tapped coil, the electromagnetic actuating device (102) with the driving coil (102′) having a driving tap (T1), a holding tap (T2) and a common connector (T0) is operatively controlled by the switching device (101) to switch the driving coil (102′) from relatively lower impedance being electrically actuated for excitation to higher impedance being holding electrification for excitation, wherein the switching methods include:

(1) The electromagnetic actuating device (102) with the driving coil (102′) having a driving tap (T1), a holding tap (T2) and a common connector (T0) is operatively controlled by a manual-sequential operating switching device (101) to switch the driving coil (102′) from relatively lower impedance being electrically actuated for excitation to higher impedance being holding electrification for excitation; or

(2) The electromagnetic actuating device (102) with the driving coil (102′) having a driving tap (T1), a holding tap (T2) and a common connector (T0) is operatively controlled by the switching device (101) with time delay control function thereby allowing the driving coil (102′) to appear relatively lower impedance being electrically actuated for excitation is switched to appear higher impedance after a setting time delay to hold electrification for excitation; or

(3) By detecting the excited current value passing through the electrified electromagnetic actuating device with the driving coil (102′) having a driving tap (T1) and a common connector (T0), when the excited current value passing through the electrified electromagnetic actuating device with the driving coil (102′) having a driving tap (T1) and a common connector (T0) □ the setting current value, or □ the status of setting current value exceeding over the setting time, the switching device (101) is driven to operatively control the driving coil (102′) to be switched to have a holding tap (T2) and a common connector (T0) to appear higher impedance thereby holding electrification for excitation; or

(4) The switching device (101) is operatively controlled by two or more than two methods of the above said (1)(2)(3);

The electromagnetic actuating devices (102): It is the device installed with a AC or DC powered driving coil (102′) having a driving tap (T1), a holding tap (T2) and a common connector (T0), wherein it includes conventional normal close or normal open type electromagnetic brakes, normal close or normal open type electromagnetic clutches, normal close or normal open type electromagnetic switches, normal close or normal open type electromagnetic relays, normal close or normal open type solenoid valves, etc. as well as electromagnets, electromagnetic locks, spiral tube windings or other electromagnetic actuating devices with driving coils for electromagnetic driving effects, or operating type electromagnetic actuating devices which can be driven by the driving coil or operated by numerous manual or mechanical power methods; wherein the driving coil (102′) having a driving tap (T1) and a common tap (T0) that appearing lower impedance is operatively controlled by the switching device (101) to be electrically actuated for excitation and after actuation further being manipulated by the switching device (101) to be switched to have a holding tap (T2) and a common connector (T0) to appear relatively higher impedance thus holding electrification for excitation thereby saving electric power and reducing heat generation, while required operating characteristics of the electromagnetic actuating device in electrification status can still be satisfied by the electromagnetic effective force.

Said individual driving coil (102′) can be optionally constituted by conducting wires of the same or different material or the same or different conduction cross-section areas, or constituted by windings with the same or different numbers of coils.

Said driving coil (102′) can be constituted by the following:

(1) Two ends of the driving coil (102′) are respectively the holding tap (T2) and the common connector (T0), while the middle tap is the driving tap (T1). FIG. 4 is a schematic view showing that two ends of the driving coil are respectively the holding tap and the common connector, while the middle tap is the driving tap;

(2) Two ends of the driving coil (102′) are respectively the holding tap (T2) and the driving tap (T1), while the middle tap is the common connector (T0). FIG. 5 is a schematic view showing that two ends of the driving coil are respectively the holding tap and the driving tap, while the middle tap is the common connector;

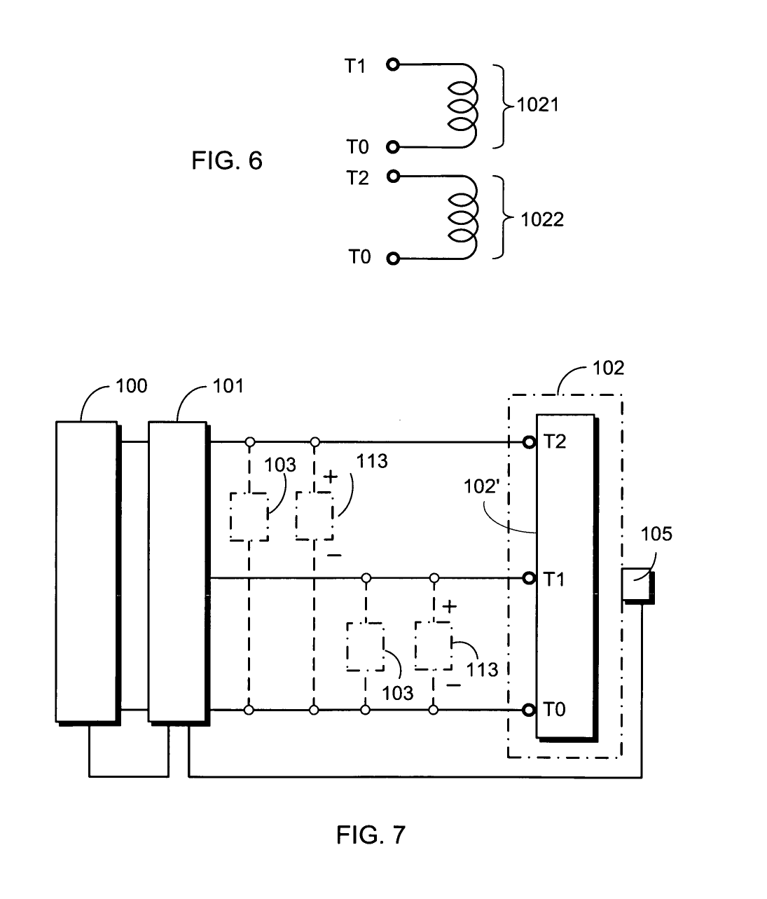

(3) The driving coil (102′) is constituted by individual driving coil (1021) and holding coil (1022), wherein two ends of the driving coil (1021) are respectively the driving tap (T1) and the common connector (T0), while two ends of the holding coil (1022) are respectively the holding tap (T2) and the common connector (T0), wherein the methods of electrical actuation can be that the driving coil (1021) and the holding coil (1022) are separately operated to be electrified for excitation, or they can be connected via common connectors (T0) while allowing the driving tap (T1) and the holding tap (T2) to be electrified for excitation. FIG. 6 is a schematic view showing that the driving coil is constituted by individual driving coil and holding coil;

The surge absorption devices (103), (113): The AC or DC surge absorption devices being optionally installed according to specifications of electromagnetic actuating devices are respectively parallel connected with the driving coil (102′) to help absorbing the produced inductance of counter-electric potential in the driving coil (102′) when the driving coil (102′) is operated by a switching device (101) to open or close, or to appear relatively lower impedance in parallel connection or series-parallel connection, or to be switched to relatively higher impedance in series connection or series-parallel connection, wherein the surge absorption device is constituted by the following: (1) When the driving coil (102′) is powered by AC power, the AC surge absorption device (103) is installed, such as that it can be constituted by a bipolar solid state varistor, or constituted by at least two kinds of components of the resistors, inductors, bipolar capacitors, etc. in series connection, parallel connection, or series-parallel connection, or constituted by the bipolar capacitor alone, or constituted by other conventional AC surge absorption circuit devices; (2) When the driving coil (102′) is powered by lower voltage DC power, the DC surge absorption device (113) is installed, such as that it can be constituted by reverse polarity diodes in parallel connection to appear a flywheel diode with energy storage effect, or constituted by at least two kinds of components of the resistors, inductors, uni-polar or bipolar capacitors in series connection, parallel connection, or series-parallel connection, or constituted by the uni-polar or bipolar capacitor alone, or constituted by the solid state varistor or other conventional DC surge absorption devices; wherein this device can be optionally installed or not installed as required.

For electromagnetic actuating device with a driving and holding tapped coil, the driving coil (102′) of the electromagnetic actuating device having a driving tap (T1) and a holding tap (T2) and a common tap (T0) is switched from the relatively lower impedance being electrically actuated for excitation to higher impedance being holding electrification for excitation during start operation; wherein the switching method is further shown in FIG. 7 which is a circuit-block schematic view showing that the electromagnetic actuating device is installed with a position detector device to operatively control the driving coil; wherein the position detector device (105) is installed at a stable position after relative actuation between the rotor and the stator of the electromagnetic actuating device (102) or at a selected position in the stroke of actuation, so that the electromagnetic actuating device at relatively lower impedance being electrified to the selected position is through the position detector device (105) to directly switch the driving coil (102′) of said electromagnetic actuating device (102) from relatively lower impedance being electrically actuated for excitation to higher impedance being holding electrification for excitation; or the driving coil (102′) is operatively controlled by the switching device (101) being operatively controlled by the position detector device (105) to be switched from relatively lower impedance being electrically actuated for excitation to higher impedance being holding electrification for excitation;

The position detector device (105) can be constituted by pressure sensing type electromechanical switching devices or pressure-actuating spring leaf type switches, or can be constituted by optical, electromagnetic inducing type, capacitive inducing type or other conventional position sensing devices, wherein this device can be optionally installed or not installed as required.

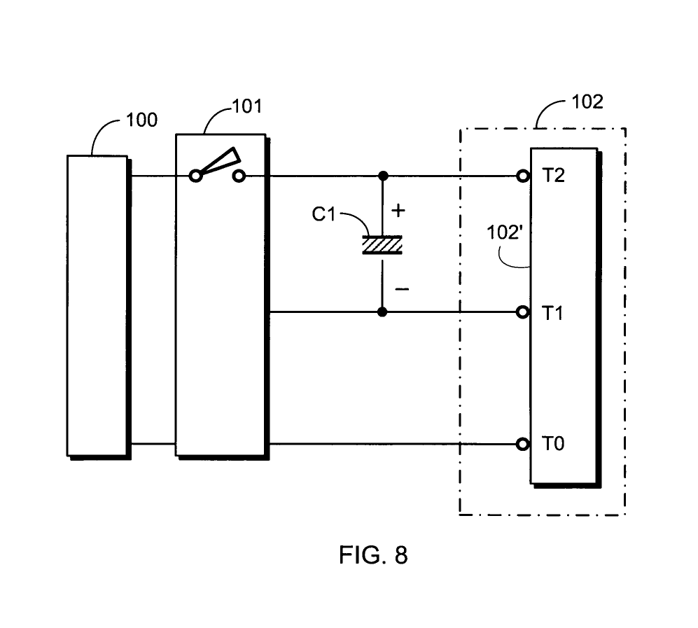

For electromagnetic actuating device with a driving and holding tapped coil, the driving coil (102′) of the electromagnetic actuating device having a driving tap (T1) and a holding tap (T2) and a common tap (T0) is switched from relatively lower impedance being electrically actuated for excitation to higher impedance being holding electrification for excitation during start operation; wherein the switching method is further shown in FIG. 8 which is a circuit schematic view of a DC power application example of the present invention showing that a charge/discharge capacitor (C1) being parallel connected between the holding tap (T2) and the driving tap (T1) is switched and cut-off power with a delay;

It mainly comprises:

A power source device (100): It is constituted by electrical machineries, electronic components, or power source supply devices containing microprocessor and relevant software with relevant power supply functions as well as voltage and current control functions to receive DC or AC power supply and to be operatively controlled by the switching device (101) to provide AC power output or DC power output of lower voltage, or DC power output of semi-wave or full waved or chopped wave, etc;

A switching device (101): It is constituted by an electromechanical switch, an electric relay, an electromagnetic switch or a solid state switching device, etc. operable by the manual, mechanical, fluid or electrical power being operated by the manual, mechanical, fluid or electrical power is through controlling the DC power supply to the driving coil (102′) of the electromagnetic actuating device (102) having a driving tap (T1), a holding tap (T2) and a common connector (T0) to provide the switching functions for electrification and power cut-off;

A charge/discharge capacitor (C1): it is constituted by various kinds of capacitor capable of charging DC power and discharging DC power and is parallel connected between the holding tap (T2) and the driving tap (T1) of the driving coil (102′) installed in the electromagnetic actuating device (102) in the same polarity of power source, wherein the charge/discharge capacitor (C1) can be optionally independently installed or integrally installed with the electromagnetic actuating device (102), or installed inside the switching device (101) as required;

The electromagnetic actuating devices (102): It is the device installed with a DC powered driving coil (102′) having a driving tap (T1), a holding tap (T2) and a common connector (T0), wherein it includes conventional normal close or normal open type electromagnetic brakes, normal close or normal open type electromagnetic clutches, normal close or normal open type electromagnetic switches, normal close or normal open type electromagnetic relays, normal close or normal open type solenoid valves, etc. as well as electromagnets, electromagnetic locks, spiral tube windings or other electromagnetic actuating devices with driving coils for electromagnetic driving effects, or operating type electromagnetic actuating devices which can be driven by driving coils or operated by numerous manual or mechanical power methods; wherein the power source device (100) is operatively controlled by the switching device (101) to supply DC power to the holding tap (T2) and the common connector (T0) of the driving coil (102′) installed in the electromagnetic actuating device (102), and the charge/discharge capacitor (C1) being parallel connected between the holding tap (T2) and the driving tap (T1) is instantly charged by the bypass divided current at the power supply instant thereby making instant current passing through the common connector (T1) and the driving tap (T1) to appear a maximum value for excitation, wherein when rising voltage of the charge/discharge capacitor (C1) in charging gradually approaches to the voltage drop between the holding tap (T2) and the driving tap (T1) until a balance is reached, DC power is switched to flow through the holding tap (T2), driving tap (T1) and common connector (T0), while the driving coil (102′) is switched to appear higher impedance for passing smaller current to hold electrification for excitation. When current is cut off by the switching device (101), stored power of the charge/discharge capacitor (C1) is discharged to the holding tap (T2) and the driving tap (T1) for excitation thereby delaying the reset time of the electromagnetic actuating device (102).

As summarized from the above descriptions, the electromagnetic actuating device with a driving coil (102′) having a driving tap (T1), a holding tap (T2) and a common connector (T0) can be operatively controlled to allow the driving coil (102′) installed in the electromagnetic actuating device (102) of relatively lower impedance to be electrically actuated for excitation so as to obtain the larger actuating power and response characteristics, then it is operatively controlled by the switching device (101) to be switched to appear relatively higher impedance thus holing electrification for excitation, thereby reducing total current passing through the driving coil (102′), while required operating characteristics of the electromagnetic actuating device (102) in electrification can still be satisfied by the electromagnetic effective force thereby saving electric power and reducing heat generation in the electromagnetic actuating device.

1. An electromagnetic actuating device with a driving and holding tapped coil is through a driving coil having a driving tap and a common connector to appear lower impedance being electrically actuated to produce a larger electromagnetic actuating force on the electromagnetic actuating device, then the driving coil is operatively controlled by the switching device to be switched to have a holding tap and a common connector to appear relatively higher impedance thereby holding electrification for excitation thus reducing total current passing through the driving coil, while required operating characteristics of the electrified electromagnetic actuating device can still be satisfied thereby saving electric power and reducing heat loss in the driving coil of the electromagnetic actuating device; it mainly comprises:
A power source device (100): it is constituted by electrical machineries, electronic components, or power source supply devices containing microprocessor and relevant software with relevant power supply functions as well as voltage and current control functions to receive DC or AC power supply and to be operatively controlled by the switching device (101) to provide AC power output or DC power output of lower voltage, or DC power output of semi-wave or full waved or chopped wave, etc;
A switching device (101): it is constituted by an electromechanical switch, an electric relay, an electromagnetic switch or a solid state switching device, etc. operable by the manual, mechanical, fluid or electrical power being operated by the manual, mechanical, fluid or electrical power is through supplying AC or DC power to the driving coil (102′) of the electromagnetic actuating device (102) having a driving tap (T1), a holding tap (T2) and a common connector (T0) to provide a switching function for electrification and power cut-off, or it is through the switchover operation by the switching device (101) to allow the driving coil (102′) having a driving tap (T1) and a common connector (T0) to appear relatively lower impedance to be electrified by passing through excited current (Ia) for excitation, wherein the driving coil (102′) being actuated for excitation by AC power input is operatively controlled by the switching device (101) to be switched to have a holding tap (T2) and a common connector (T0) to hold electrification by passing excited current (Ia) for excitation, total current on the driving coil is reduced, while operating characteristics of the electrified electromagnetic actuating device is still ensured by the electromagnetic effective force;
The electromagnetic actuating devices (102): it is the device installed with a AC or DC powered driving coil (102′) having a driving tap (T1), a holding tap (T2) and a common connector (T0) for electromagnetic driving effects, or operating type electromagnetic actuating devices which can be driven by the driving coil or operated by numerous manual or mechanical power methods; wherein the driving coil (102′) having a driving tap (T1) and a common tap (T0) that appearing lower impedance is operatively controlled by the switching device (101) to be electrically actuated for excitation and after actuation further being manipulated by the switching device (101) to be switched to have a holding tap (T2) and a common connector (T0) to appear relatively higher impedance thus holding electrification for excitation thereby saving electric power and reducing heat generation, while required operating characteristics of the electromagnetic actuating device in electrification status can still be satisfied by the electromagnetic effective force.

2. The electromagnetic actuating device with a driving and holding tapped coil as claimed in claim 1, wherein the electromagnetic actuating device (102) with the driving coil (102′) having a driving tap (T1), a holding tap (T2) and a common connector (T0) is operatively controlled by the switching device (101) to switch the driving coil (102′) from relatively lower impedance being electrically actuated for excitation to higher impedance being holding electrification for excitation, wherein the switching methods include:
(1) The electromagnetic actuating device (102) with the driving coil (102′) having a driving tap (T1), a holding tap (T2) and a common connector (T0) is operatively controlled by a manual-sequential operating switching device (101) to switch the driving coil (102′) from relatively lower impedance being electrically actuated for excitation to higher impedance being holding electrification for excitation; or
(2) The electromagnetic actuating device (102) with the driving coil (102′) having a driving tap (T1), a holding tap (T2) and a common connector (T0) is operatively controlled by the switching device (101) with time delay control function thereby allowing the driving coil (102′) to appear relatively lower impedance being electrically actuated for excitation is switched to appear higher impedance after a setting time delay to hold electrification for excitation; or
(3) By detecting the excited current value passing through the electrified electromagnetic actuating device with the driving coil (102′) having a driving tap (T1) and a common connector (T0), when the excited current value passing through the electrified electromagnetic actuating device with the driving coil (102′) having a driving tap (T1) and a common connector (T0) ≧ the setting current value, or ≧ the status of setting current value exceeding over the setting time, the switching device (101) is driven to operatively control the driving coil (102′) to be switched to have a holding tap (T2) and a common connector (T0) to appear higher impedance thereby holding electrification for excitation; or
(4) The switching device (101) is operatively controlled by two or more than two methods of the above said (1)(2)(3).

3. The electromagnetic actuating device with a driving and holding tapped coil as claimed in claim 1, wherein the driving coil (102′) can be optionally constituted by conducting wires of the same or different material or the same or different conduction cross-section areas, or constituted by windings with the same or different numbers of coils.

4. The electromagnetic actuating device with a driving and holding tapped coil as claimed in claim 3, wherein the driving coil (102′) is constituted by the following:
(1) Two ends of the driving coil (102′) are respectively the holding tap (T2) and the common connector (T0), while the middle tap is the driving tap (T1);
(2) Two ends of the driving coil (102′) are respectively the holding tap (T2) and the driving tap (T1), while the middle tap is the common connector (T0);
(3) The driving coil (102′) is constituted by individual driving coil (1021) and holding coil (1022), wherein two ends of the driving coil (1021) are respectively the driving tap (T1) and the common connector (T0), while two ends of the holding coil (1022) are respectively the holding tap (T2) and the common connector (T0), wherein the methods of electrical actuation can be that the driving coil (1021) and the holding coil (1022) are separately operated to be electrified for excitation.

5. The electromagnetic actuating device with a driving and holding tapped coil as claimed in claim 1, wherein the driving coil (102′) of electromagnetic actuating device (102) having a driving tap (T1), a holding tap (T2) and a common connector (T0) is switched from relatively lower impedance being electrically actuated for excitation to higher impedance being holding electrification for excitation, wherein the switching methods further include the position detector device (105) is installed at a stable position after relative actuation between the rotor and the stator of the electromagnetic actuating device (102) or at a selected position in the stroke of actuation, so that the electromagnetic actuating device at relatively lower impedance being electrified to the selected position is through the position detector device (105) to directly switch the driving coil (102′) of said electromagnetic actuating device (102) from relatively lower impedance being electrically actuated for excitation to higher impedance being holding electrification for excitation; or the driving coil (102′) is operatively controlled by the switching device (101) being operatively controlled by the position detector device (105) to be switched from relatively lower impedance being electrically actuated for excitation to higher impedance being holding electrification for excitation;
The position detector device (105) can be constituted by pressure sensing type electromechanical switching devices or pressure-actuating spring leaf type switches, or can be constituted by optical, electromagnetic inducing type, capacitive inducing type or other conventional position sensing devices, wherein this device can be optionally installed or not installed as required.

6. An electromagnetic actuating device with a driving and holding tapped coil as claimed in claim 1, wherein the driving coil (102′) of the electromagnetic actuating device (102) having a driving tap (T1) and a holding tap (T2) and a common tap (T0) is switched from relatively lower impedance being electrically actuated for excitation to higher impedance being holding electrification for excitation during start operation; it mainly comprises:
A power source device (100): it is constituted by electrical machineries, electronic components, or power source supply devices containing microprocessor and relevant software with relevant power supply functions as well as voltage and current control functions to receive DC or AC power supply and to be operatively controlled by the switching device (101) to provide AC power output or DC power output of lower voltage, or DC power output of semi-wave or full waved or chopped wave, etc;
A switching device (101): it is constituted by an electromechanical switch, an electric relay, an electromagnetic switch or a solid state switching device, etc operable by the manual, mechanical, fluid or electrical power being operated by the manual, mechanical, fluid or electrical power is through controlling the DC power supply to the driving coil (102′) of the electromagnetic actuating device (102) having a driving tap (T1), a holding tap (T2) and a common connector (T0) to provide the switching functions for electrification and power cut-off;
A charge/discharge capacitor (C1): it is constituted by various kinds of capacitor capable of charging DC power and discharging DC power and is parallel connected between the holding tap (T2) and the driving tap (T1) of the driving coil (102′) installed in the electromagnetic actuating device (102) in the same polarity of power source, wherein the charge/discharge capacitor (C1) can be optionally independently installed or integrally installed with the electromagnetic actuating device (102), or installed inside the switching device (101) as required;
The electromagnetic actuating devices (102): it is the device installed with a DC powered driving coil (102′) having a driving tap (T1), a holding tap (T2) and a common connector (T0), wherein it includes conventional normal close or normal open type electromagnetic brakes, normal close or normal open type electromagnetic clutches, normal close or normal open type electromagnetic switches, normal close or normal open type electromagnetic relays, normal close or normal open type solenoid valves, etc. as well as electromagnets, electromagnetic locks, spiral tube windings or other electromagnetic actuating devices with driving coils for electromagnetic driving effects, or operating type electromagnetic actuating devices which can be driven by driving coils or operated by numerous manual or mechanical power methods; wherein the power source device (100) is operatively controlled by the switching device (101) to supply DC power to the holding tap (T2) and the common connector (T0) of the driving coil (102′) installed in the electromagnetic actuating device (102), and the charge/discharge capacitor being parallel connected between the holding tap (T2) and the driving tap (T1) is instantly charged by the bypass divided current at the power supply instant thereby making instant current passing through the common connector (T1) and the driving tap (T1) to appear a maximum value for excitation, wherein when rising voltage of the charge/discharge capacitor (C1) in charging gradually approaches to the voltage drop between the holding tap (T2) and the driving tap (T1) until a balance is reached, DC power is switched to flow through the holding tap (T2), driving tap (T1) and common connector (T0), while the driving coil (102′) is switched to appear higher impedance for passing smaller current to hold electrification for excitation. When current is cut off by the switching device (101), stored power of the charge/discharge capacitor (C1) is discharged to the holding tap (T2) and the driving tap (T1) for excitation thereby delaying the reset time of the electromagnetic actuating device (102).

7. The electromagnetic actuating device with a driving and holding tapped coil as claimed in claim 1, wherein the AC or DC surge absorption devices being optionally installed according to specifications of electromagnetic actuating devices are respectively parallel connected with the driving coil (102′) to help absorbing the produced inductance of counter-electric potential in the driving coil (102′) when the driving coil (102′) is operated by a switching device (101) to open or close, or to appear relatively lower impedance in parallel connection or series-parallel connection, or to be switched to relatively higher impedance in series connection or series-parallel connection, wherein the surge absorption device is constituted by the following: (1) When the driving coil (102′) is powered by AC power, the AC surge absorption device (103) is installed, such as that it can be constituted by a bipolar solid state varistor, or constituted by at least two kinds of components of the resistors, inductors, bipolar capacitors, etc. in series connection, parallel connection, or series-parallel connection, or constituted by the bipolar capacitor alone, or constituted by other conventional AC surge absorption circuit devices; (2) When the driving coil (102′) is powered by lower voltage DC power, the DC surge absorption device (113) is installed, such as that it can be constituted by reverse polarity diodes in parallel connection to appear a flywheel diode with energy storage effect, or constituted by at least two kinds of components of the resistors, inductors, uni-polar or bipolar capacitors in series connection, parallel connection, or series-parallel connection, or constituted by the uni-polar or bipolar capacitor alone, or constituted by the solid state varistor or other conventional DC surge absorption devices; wherein this device can be optionally installed or not installed as required.

8. The electromagnetic actuating device with a driving and holding tapped coil as claimed in claim 1, wherein the electromagnetic actuating device with the driving coil having a driving tap, a holding tap and a common connector includes applications for normal close or normal open type electromagnetic brakes, normal close or normal open type electromagnetic clutches, normal close or normal open type electromagnetic switches, normal close or normal open type electromagnetic relays, normal close or normal open type solenoid valves, etc. as well as electromagnets, electromagnetic locks, spiral tube windings or other electromagnetic actuating devices with driving coils for electromagnetic driving effects, or operating type electromagnetic actuating devices which can be driven by driving coils or operated by numerous manual or mechanical power methods.
